(19) United States
(12) Patent Application Publication
(10) Pub. No.: US 2025/0378505 A1
(43) Pub. Date: Dec. 11, 2025

(54) METHOD AND SYSTEM FOR CREATION, TRANSMITTAL AND STORAGE OF A FINANCIAL EVENT AND DIGITAL LEDGER AND PHYSICAL NEGOTIABLE INSTRUMENT

(71) Applicant: Larence Hilton, Highland, UT (US)

(72) Inventor: Larence Hilton, Highland, UT (US)

(21) Appl. No.: 19/085,929

(22) Filed: Mar. 20, 2025

Related U.S. Application Data
(60) Provisional application No. 63/567,869, filed on Mar. 20, 2024.

(51) Int. Cl. G06Q 40/12; G06F 21/60; G06Q 30/02; H04W 4/14

(52) U.S. Cl. CPC G06Q 40/12; G06F 21/602; G06Q 30/0281; H04W 4/14

(57) ABSTRACT

A system and method for creating, transmitting and storage of a financial event recorded in a digital ledger, including transactions making use of virtual currency and tangible currency, with transaction authentication means.

### FIELD OF THE INVENTION

This invention relates to a system and method for performing transactions with exchangeable legal tender, and more particularly relates to system and method that creates a financial event in computer-readable memory.

### BACKGROUND

### Description of the Related Art

A decentralized, digital ledger operable to prevents double spending of digital currency, requiring consensus to debit amongst a member and merchant, is desirable in the art. There exists no means in the art of efficiently recording, in a ledger in computer-readable memory, a transaction in which tangible, physical currency is used or a combination of tangible currency and digital currency, and no method or system of creating a financial event in computer-readable memory memorializing and confirming such a transaction.

Although digital currencies such as Bitcoin are known in the art, merchants have no efficient means at their disposal of accepting it in connection with a tangible physical currency, or of remitting change in digital form to a purchaser of a consumer good or product.

Throughout history, the clearing of negotiable instruments, such as checks and money orders, has constituted a paper-intensive process. Negotiable instruments such as the dollar bill are bearer currencies, meaning the bearer of the dollar bill or negotiable instrument is the presumed owner.

Bearers may enter a financial institution, such as a bank, and present a negotiable instrument for a particular monetary value to be cashed or deposited. The bank or financial institution may then credit an account of the customer or convert the negotiable instrument into other forms of currency.

In the case of checks, the bank sends the negotiable instrument to a clearinghouse (alternatively referred to as their check processor). This clearinghouse may then route the negotiable instrument to second clearinghouse associated with the issuing bank. This second clearinghouse may process and verify the negotiable instrument. Thereafter, the clearinghouse may transmit or send funds to the bank deposit for the value of the negotiable instrument.

Although negotiable instruments, such as dollars, have value imparted to them by the demand of consumers and bearers within a larger economy for them, the physical components of the dollar bill have no inherent value, typically largely comprising only paper, linen and ink.

In the past, the value of the dollar was directly tied to the value of gold, which has had ubiquitous value throughout history (along with various other precious metals). Due to fluctuations in value of the dollar experienced in relation to the world market and the need to protect the United States gold reserves, the Gold Standard was suspended and reinstated several times until it was finally Removed in 1963. In that year, the United States resolved the situation by following the example of most other nations and changing their currency system. Instead of backing the dollar with gold or other precious metals held in reserve, U.S. money became a fiat currency, which is not directly backed by any physical commodity.

As such, in the case of collapse of the U.S. dollar because of hyper-inflation or the collapse of the U.S. economy in situations like war, the physical dollars bills would have no inherent value.

There is a need in the art for a negotiable instrument, including a bill, which has inherent value and incorporates precious metals. In view of the foregoing, it is clear that such a negotiable instrument would be desirable.

### SUMMARY

From the foregoing discussion, it should be apparent that a need exists for a system and method for creation, transmittal and storage of a financial event and digital ledger. Beneficially, such a system and method would provide a means of remitting and confirming a transaction with member and merchant confirmation; and further establishing that a transaction has occurred.

The present invention has been developed in response to the present state of the art, and in particular, in response to the problems and needs in the art that have not yet been fully solved by currently available models. Accordingly, the present invention has been developed to provide a system and method for performing transactions with exchangeable cryptocurrency and legal tender that overcome many or all of the above-discussed shortcomings in the art. As such, the present application provides: a computer-implemented method for creating a financial event file in computer-readable memory and facilitating a bi-directional financial transaction, the steps of the method comprising: incorporating a merchant into a member network under the control of a technology provider by creating an encrypted virtual merchant account for the merchant in computer-readable memory within an RDBMS, the virtual merchant account comprising one or more of a name, mobile phone number, email, a unique numeric identifier exclusively associated with the merchant, and an account balance; incorporating a member into a member network under the control of the technology provider by creating an encrypted virtual member account for the member in computer-readable memory within an RDBMS, the virtual member account comprising one or more of a name, mobile phone number, email, a unique numeric identifier exclusively associated with the merchant, and an account balance; maintaining an encrypted global ledger of all transfers and balance changes occurring in a plurality of virtual member accounts and a plurality of virtual merchant accounts; accepting into computer-readable memory from a merchant a financial event file originating with said merchant, created on a user interface displayed on a DPD, said DPD in logical communication with the technology provider via a WAN, the financial event file comprising: the unique numeric identifier exclusively-associated with the merchant; the unique numeric identifier exclusively-associated with the merchant; a description of one of a good and service being purchased; one of an email and a mobile phone number of the member; a purchase price expressed as a float; a first payment amount expressed as a float; a second payment amount expressed as a float; a refund amount expressed as a float and indicative of an amount of tangible currency to be refunded to the member.

The method further comprises uploading the financial event file by the merchant to the technology provider via the WAN; downloading the financial event file by the member from the technology provider via the WAN; transmitting from the technology provider to the member a unique confirmation number to be given to the merchant manually by the member; uploading the unique confirmation number by the merchant to the technology provider via the WAN; allocating digital currency from the virtual member account to the virtual merchant account in response to receipt of the unique confirmation number and authentication of an accuracy of the confirmation number; recording into computer-readable memory a provider response to the item request, the provider response comprising an integer indicative of a price of the consumer good; and recording into computer-readable memory a consumer acceptance of the provider response.

The account balance may indicate a quantity of digital currency escrowed in trust with the technology provider. In some embodiments, the method further comprises recording into computer-readable memory on a signal bearing medium geolocation information from a merchant and a member.

The method, in some embodiments, further comprises relaying to the member by the technology provider with real-time textual communication an SMS comprising the unique confirmation identifier.

The method may further comprise relaying to the merchant a Boolean value evaluating as true in response to authentication of the unique confirmation.

Accordingly, the present invention has been developed to provide a physical negotiable instrument comprising: a flexible backing material; a plurality of markings layered upon the flexible backing material, the markings comprising: a predetermined quantity of a precious metal, a serial number, a first denomination indicator indicating a total predetermined weight of a first precious metal incorporated into the markings, a precious metal identifier, a seal indicating a source of origin of the physical negotiable instrument.

The flexible backing material may comprise a foil comprising a precious metal. One or more of the markings may be layered upon the flexible backing material comprise woven fibers of precious metals in various embodiments.

The markings may be layered upon the flexible backing material and bonded thereto. The flexible backing material may comprise a polymeric sheet. The predetermined quantity of precious metal may comprise one of the following fractions of an ounce: 1/4000, 1/5000, 1/20, 1/40, 1/100, ¼, 1/200, 1/100, 1/10 and ½.

In some embodiments, the physical negotiable instrument further comprises a second denomination indicator indicating a total predetermined weight of a second precious metal incorporated into the markings.

The physical negotiable instrument may be produced for recognition by a government as a legal tender.

Both a reverse surface and an obverse surface of the physical negotiable instrument may be clear-coated with one of a flexible polymeric, silicone or urethane layer, enveloping the markings between clear-coated surfaces, in alternate embodiments.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a data entity diagram illustrating one method of creating and transmitting a financial event and digital ledger in accordance with the present invention;

FIG. 2 is a user interface illustrating one method of creating and transmitting a financial event and digital ledger in accordance with the present invention;

FIG. 3 is a block diagram illustrating one system of creating and transmitting a financial event and digital ledger in accordance with the present invention;

FIG. 4 is a block diagram illustrating one embodiment of a financial event in accordance with the present invention;

FIG. 5 is a flow chart illustrating the steps of a method of creating and transmitting a financial event in accordance with the present invention;

FIG. 6 is a block layout diagram illustrating the steps of a method of creating and transmitting a financial event in accordance with the present invention; and

FIG. 7 is a forward perspective view illustrating one embodiment of a physical negotiable instrument in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

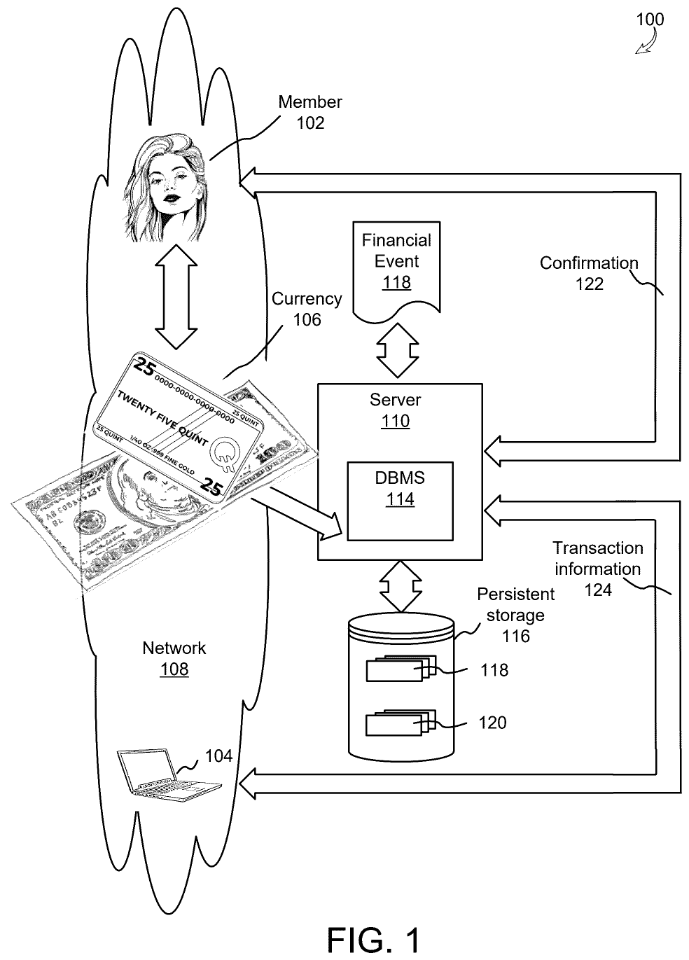

FIG. 1 is a data entity diagram illustrating one method of creating and transmitting a financial event and digital ledger in accordance with the present invention.

The system or method 100 comprises a server 110, a database management system (DBMS) 114, persistent storage 116, stored financial events 118, stored historical data 120, a wireless network 108, a plurality of member 102, a merchant 104, transaction information 124, and a confirmation 122.

Typically, the server 110 comprises one or more central processing units executing software and/or firmware to control and manage the other components within the system or method 100. In one embodiment, the server 110 comprises hardware and/or software more commonly referred to as a Multiple Virtual Storage (MVS), OS/390, zSeries/Operating System (z/OS), UNIX, Linux, or Windows.

The server 110 may comprise a server cluster with firewalls, load balancer, and database servers having Apache® and/or other software applications well-known to those of skill in the art. The server 110, in the shown embodiment, comprises a database management system (DBMS) 114 or relational database management system (RDBMS), such as Oracle, MySQL, SQL, FireBird, IBM DB2®, or the like.

The server 110 is in logical communication with one or more members 102 and one or more merchants 104 through a networked environment 108, such as local area network (LAN) or wide area network (WAN). The server 110 may communicate with members 102 and merchants 104, sending queues, transaction information 124, and confirmations 122, using variations of the Simple Mail Transfer Protocol (SMTP), Internet Message Access Protocol (IMAP), Post Office Protocol (POP), SMS, or other protocols well-known to those of skill in the art.

The merchant 104 and member 102 may use (or comprise) a smartphone, desktop or other DPD which, internally or externally, may comprise an Interactive Voice Response (IVR), which recognizes natural voice communication or DTMF keypad input.

In the present invention, the server 110 routes information between the members 102 and merchants 104. The server 110 is in logical communication with the DPDs of the merchants 104 and the members 102. The server 110 is in logical communication via a network 108 such as the Internet with the cellular phones or DPDs of members 102 and merchants 104, consumers 918, including DPDs such as laptops, mobile phones, digital cameras, and the like.

In the present invention, as further described in detail above and below, merchants 104 create financial events 118 on their DPDs which are then relayed to the server 110. In alternative embodiments, the financial events 118 are created by the members 102. These financial events 118 comprise information about a purchase of a retail product, goods, or services for which a member 102 wishes to remit payment. The server 110 facilitates a real-time, synchronous or asynchronous negotiation between the member 102 and the merchant 104 via a WAN such as the Internet.

The server does not collect payment from the member 102 nor merchant 104 in the shown embodiment, rather the server 110 allocates digital currency between a member 102 and a merchant 104. In some embodiments, the server 110 allocates payment from a member 102 to a merchant 104 after the consumer good(s) are delivered, remunerating a merchant 104 in digital currency in accordance with a predetermined equivalency conversion multiplier representing the value of the digital currency relative to a legal tender being used by the member 102.

The members 102 may comprise any person, company, or organization that is potentially a customer of a merchant 104, which may be another person, company, or organization. Each member 102 and merchant 104 are incorporated into a member network comprising individuals and entities (or merchants 104 and members 102) who have registered with the server 110. For the purposes here, the terms “incorporate” and “incorporation” denote the act of formally enrolling a member 102 or merchant 104 into a member network by creating a secure, virtual account for them with the technology provider controlling the server 110.

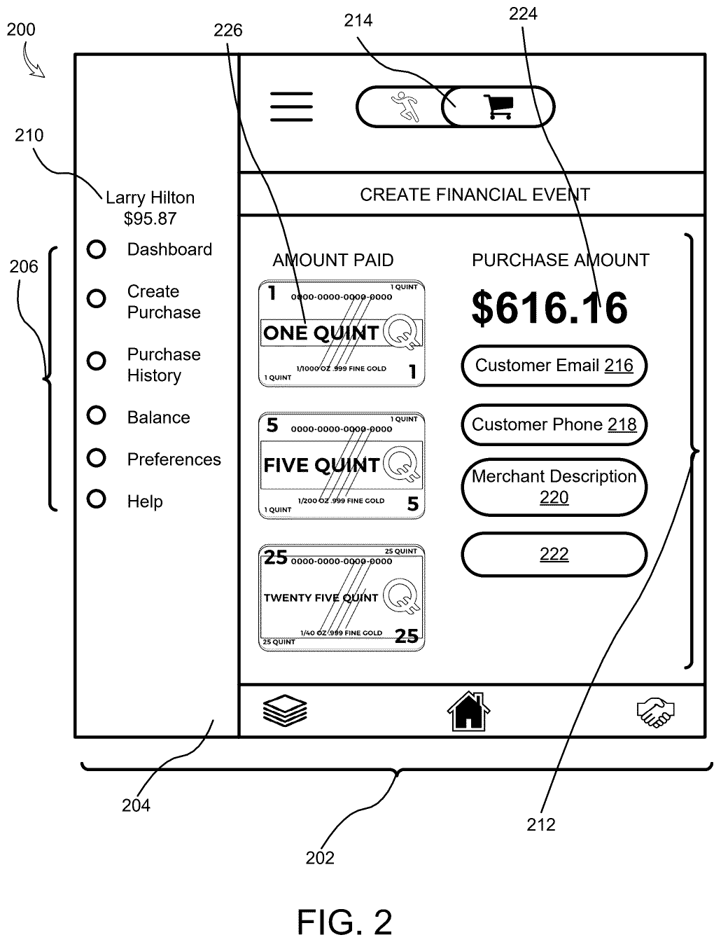

Merchants 104 and members 102 become incorporated when they create accounts with the server 110 by uploading personal identifying information, including one or more of: an address, an email address, a telephone number, and the like. In typical embodiments, the registration takes place via a browser or user interface 200 such as that shown in FIG. 2, but may also be sent to the server 110 using programs well-known to those of skill in the art, such as Microsoft Outlook, Thunderbird, Gmail, Yahoo! Mail, and the like. In other embodiments, the members 102 and merchants 104 are incorporated by receiving personal information via an API from a social media provider such as Google®, Facebook®, Twitter®, Instagram®, Snapchat®, or other social media providers known to those of skill in the art.

Like the members 102, the merchants 104 may comprise any person, company, or organization that is potentially a merchant of another person, company, or organization. The consumer product being purchased by the member 102 may comprise any valuable item or service which can be purchased, tangible, or intangible. Examples of consumer products may include food, housing, tools, machines, fuel and the like. Services may include construction services, legal services, plumbing services, and the like.

The computers under the control of the members 102 and merchants 104 may comprise any system, apparatus, or computer program running on one or more data processing devices (DPDs), such as a server 110, computer workstation, router, mainframe computer, or the like. In various embodiments, the DPD comprises one or more processors. The processor is a computing device well-known to those in the art and may include an application-specific integrated circuit (“ASIC”).

Financial events 118 are stored in persistent storage 116. In various embodiments, the server 110 may comprise, or be in logical communication with, an SMS gateway provider which relays short messages between the server 110 and/or one or more merchants 104 and members 102.

FIG. 2 is a user interface 200 illustrating one method of creating and transmitting a financial event and digital ledger in accordance with the present invention.

The user interface 200 includes interfaces that can be displayed to members 102 or merchants 104 in either a member role or a merchant role in accordance with the present invention. The user interface 200 show various functional features that can be provided in the system 200 and method 200 described herein. For example, FIG. 2 shows one embodiment of a dashboard page, indicated generally at 202, on which a member 102 can select from many options, indicated generally at 206, to navigate around the user interface 200. A switch 214 can be activated to allow a user to choose between being interfacing as a member 102 or merchant 104.

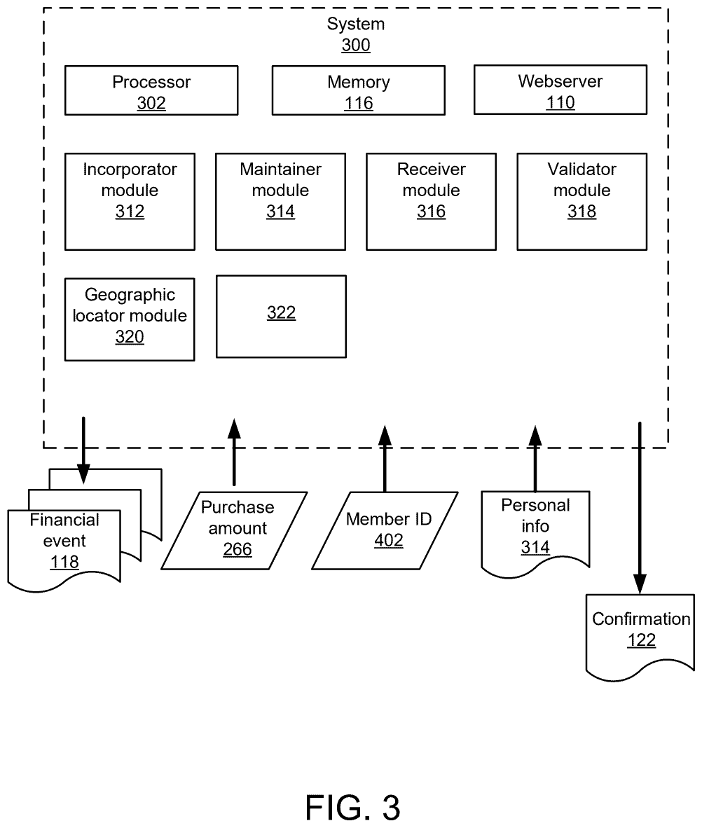

FIG. 3 is a block diagram illustrating one system 300 of creating and transmitting a financial event and digital ledger in accordance with the present invention.

Each of the modules 1110-1132 comprises the front end logic necessary to realize their respective described functions. The system 300 may comprise an application-specific integrated circuit (“ASIC”).

The system 300 may comprise a transmitter and receiver with the logic necessary to receive and transmit bitstreams (i.e. data streams). The system 300 modules may include the software, firmware, and hardware necessary to receive and process SMS messages and media between merchants 104 and members 102, including buffers, data unloaders, video unloaders, and the like.

The system 300 includes a request an incorporator module 312 configured to incorporate members 102 and merchants 104 with the technology provider and the server 110, which takes uploaded input from the member 102 and the merchant 104 a consumer 918 and converts said input into a computer-readable file constituting a virtual account which is stored in computer-readable memory. In the case of members 102, this file constitutes a virtual member account. In the case of merchants 104, this file constitutes a virtual member account.

The system 300 may comprise a maintainer module 314 configured to maintain a global ledger having entries representative of financial events 118, which global ledger may be encrypted and stored within the RDBMS 114 in computer-readable memory.

The validator module 318 validates that a confirmation identifier 418 is accurate by cross-referencing the confirmation identifier 418 received via upload from the member 102 with a confirmation entry in the global ledger then expressing a confirmation Boolean as true if the confirmation identifier matches the confirmation entry.

The purchase amount 266 may be uploaded by the merchant 104 to the server 110 within the financial event 118 or as a separate float in computer-readable memory. The unique identifier 402 exclusively associated with the member 102 is also uploaded by the merchant 104 after prompting the member 102 to provide it. Personal information 314 of the member 102 is also uploaded to the technology provider, including one or more of a name, email address, and mobile phone number.

A confirmation ID 122 (i.e., a unique confirmation identifier) may be relayed to the member 102 via an SMS gateway.

A geographic locator module 320 may be configured to confirm that DPDs of a merchant 104 and a member 102 are within close geographic proximity one another, within 100 feet in some embodiments. The geographic locator module 320 may make this confirmation using GPS data uploaded by the DPDs under the control of the member 102 and the merchant 104.

The notification module 1120 sends notifications to providers 914 that consumer requests 920 have been received, in some cases via SMS. The aggregator module 1124 aggregates money received from consumers, 918 for delivery of consumer goods, and distributes this money in part to providers 914 in accordance with a predetermined remuneration criteria, which predetermined remuneration criteria may be established by the technology provider.

A notification module 322 is also shown and may be configured to relay the unique confirmation identifier 122 to the member 102.

In other embodiments, the specie or physical negotiable instrument comprises a legend reading in whole or in part as follows: “exchangeable for money” and/or “payable on demand” and/or “unconditional promise” and/or “to pay a fixed amount of money to the bearer” and/or “legal tender to bearer upon demand.”

The specie negotiable instrument may be exchangeable for U.S. tender.

The specie negotiable instrument may be exchangeable for U.S. tender.

The specie negotiable instrument bears an unconditional promise to pay a fixed amount of money to a bearer of the specie negotiable instrument upon demand. This fixed amount of money may be in gold, silver, platinum, other precious metals, or other U.S. tender.

The specie negotiable instrument 300 may be made through a sputtering process in which gold or another precious metal is sputtered onto a polymer. A second layer of polymer may then be laid over the sputtered gold. This process creates a 3D effect in which the sputtered gold appears to be in relief. At an atomic level, atom by atom, the gold is laid down.

Alternatively, the specie negotiable instrument may be printed on a polymer infused with gold.

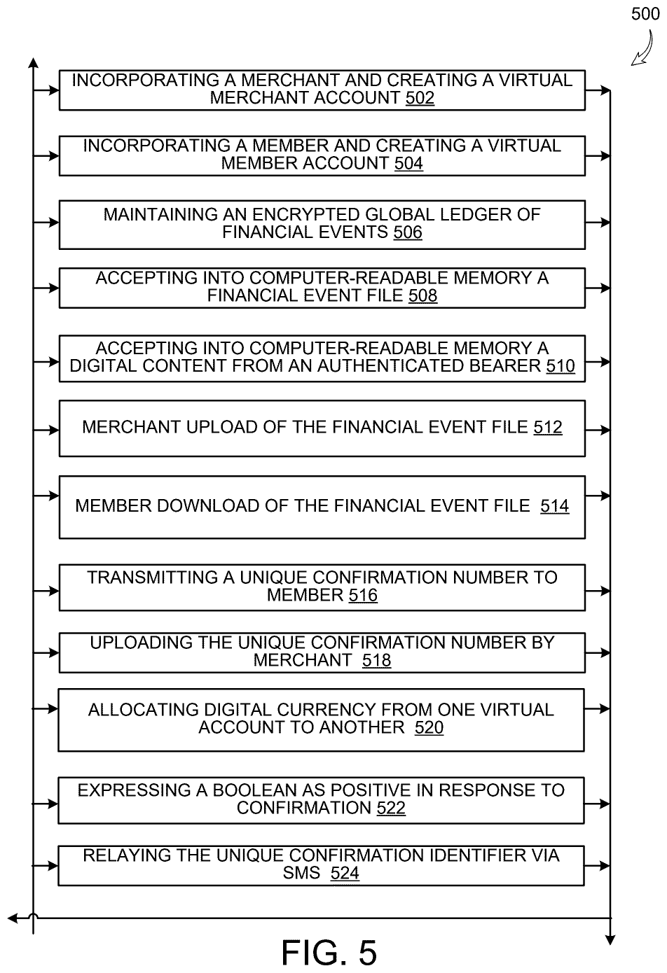

FIG. 5 is a flow chart illustrating the steps of a method 500 of creating and transmitting a financial event in accordance with the present invention. FIG. 5 illustrates an exemplary method 500. The method 600 in the disclosed embodiments substantially includes the steps necessary to carry out the functions presented above with respect to the operation of the described system and method 300. In one embodiment, the method 500 includes an initial Step 502 of incorporating a merchant into a member network under the control of a technology provider by creating an encrypted virtual merchant account for the merchant in computer-readable memory within an RDBMS, the virtual merchant account comprising one or more of a name, mobile phone number, email, a unique numeric identifier exclusively associated with the merchant, and an account balance.

The method 500 proceeds by incorporating 504 a member into a member network under the control of the technology provider by creating an encrypted virtual member account for the member in computer-readable memory within an RDBMS, the virtual member account comprising one or more of a name, mobile phone number, email, a unique numeric identifier exclusively associated with the merchant, and an account balance.

The method 500 comprises a step of maintaining 506 an encrypted global ledger of all transfers and balance changes occurring in a plurality of virtual member accounts and a plurality of virtual merchant accounts.

Next may be a step 508 of accepting into computer-readable memory from a merchant 104 a financial event file 118 originating with said merchant 104, created on a user interface 200 displayed on the GUI of a DPD, said DPD in logical communication with the technology provider via a WAN, the financial event file 118 comprising: the unique numeric identifier exclusively-associated with the merchant; the unique numeric identifier exclusively-associated with the merchant; a description of one of a good and service being purchased; one of an email and a mobile phone number of the member; a purchase price expressed as a float; a first payment amount expressed as a float; a second payment amount expressed as a float; a refund amount expressed as a float and indicative of an amount of tangible currency to be refunded to the member.

The financial event file 118 may by uploaded 512 by the merchant 104 to the technology provider via the WAN.

In some embodiments, the member 102 downloads 514 the financial event file from the technology provider via the WAN. A unique confirmation number may be transmitted 516 from the technology provider to the member 102 to be given to the merchant 104 manually by the member 102.

The method 500 progresses with uploading 518 the unique confirmation number by the merchant 104 to the technology provider via the WAN, then allocating 520 digital currency from the virtual member account to the virtual merchant account in response to receipt of the unique confirmation number and authentication of an accuracy of the confirmation number.

A provider response may be recorded into computer-readable memory, the provider response comprising an integer indicative of a price of the consumer good; and recording into computer-readable memory a consumer acceptance of the provider response.

The account balance may indicate a quantity of digital currency escrowed in trust with the technology provider. The method 500 may comprise recording into computer-readable memory on a signal bearing medium geolocation information from a merchant and a member.

The method 500 may further comprise relaying 524 to the member by the technology provider with real-time textual communication an SMS comprising the unique confirmation identifier. The method 500 may also comprise expressing 522 a Boolean value evaluating as true in response to authentication of the unique confirmation.

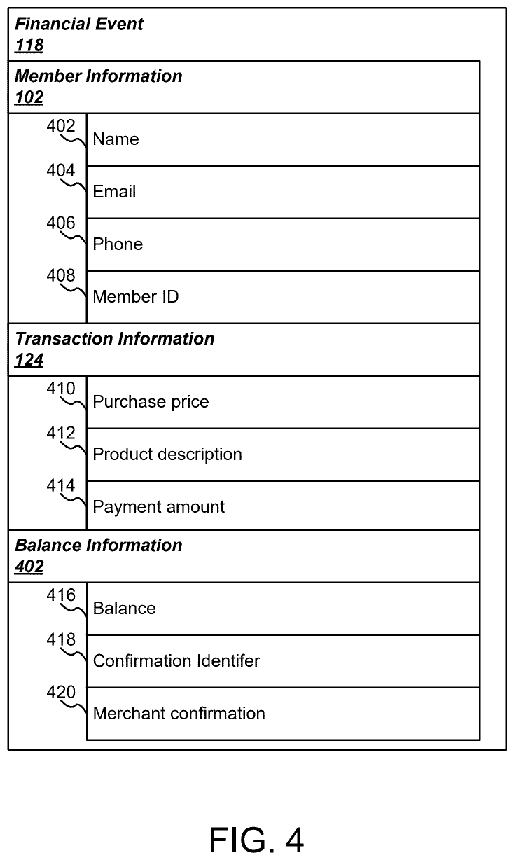

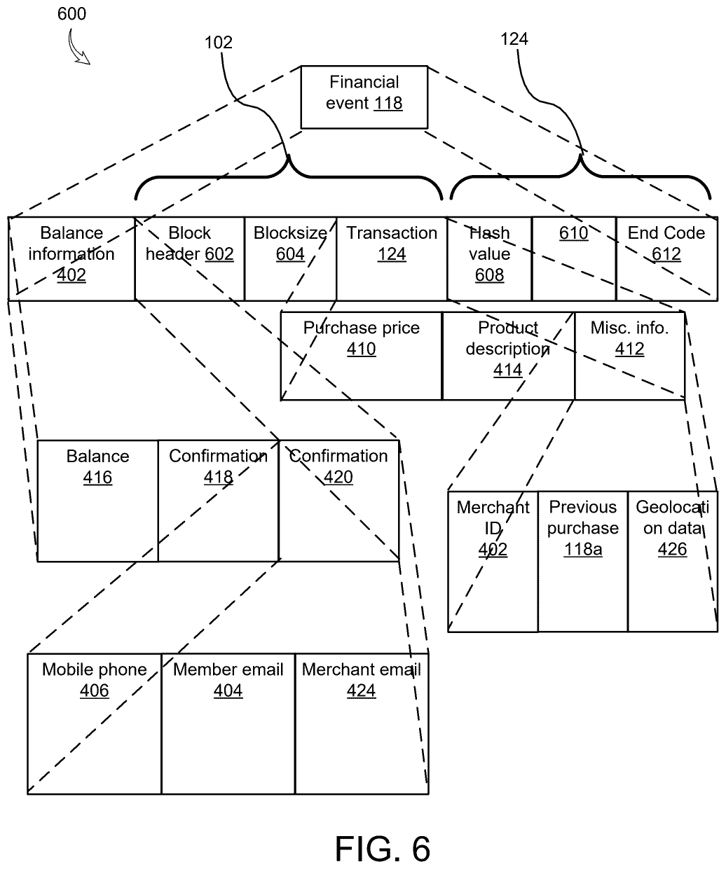

FIG. 4 and FIG. 6 illustrate block layout diagrams of the steps of a method of creating and transmitting a financial event in accordance with the present invention.

The financial event 118 comprises, in some embodiments, a computer-readable file stored in persistent memory 116 under the control of a database management system (DBMS) or a relational database management system (RDBMS) 114. The financial event 118 (i.e., financial event file) may be transmitted over a signal-bearing medium to the technology provider, member 102 and/or merchant 104.

The technology provider, controlling the server 110, in the shown embodiment, may comprise one or more computer programs running on one or more data processing devices (DPDs). The technology provider may also comprise an individual or organization.

The financial event 118 comprises various content units or packets, which, in various embodiments of the present invention, may comprise strings, arrays, integers, floats, video signals, audio signals, URLs, separate computer files, and the like.

In the shown embodiments, a technology provider receives, encodes, and/or modifies information in the financial event 118 received via the WAN from one or more of the member 102 and the merchant 104, then records historical financial event files 118.

The financial event file 118 may be broadcast and encoded in one of any number of various data encodings well-known to those of skill in the art.

The financial event file 118 may comprise balance information 402 which comprises a balance 416 in a merchant 104 or member 102 virtual account. A confirmation Boolean 418 which is evaluated (or expressed) as positive in response to receiving an authenticated unique confirmation ID 122 from the member 102. In some alternative embodiments, the balance information 402 also comprises a merchant confirmation Boolean 420 which may contain information about the merchant 104, including a mobile phone number 506, a member email 404, and a merchant email 424.

In various embodiments, transaction data 124 is included in the financial event 118, including a purchase price 410 which may be a float, a production description 414 which comprise a character string, and miscellaneous information 412 which may comprise a unique merchant identifier expressed as an integer and exclusively associated with the merchant 104 and the merchant's 104 virtual account.

The geolocation data 426 may comprise integers or floating points representing global positioning system (GPS) coordinates of the merchant 104 and/or member 102. The geolocation data 426 may also comprise a character string representing a mailing address and/or physical address of the merchant 104 or member 102.

It is an object of the present invention to enable exchange of virtual monies and also tangible currency in a way that combines the benefits of using both virtual (or digital) currency and tangible legal tender in a transaction. For this reason, the transaction information 124 may comprise floats representative of an amount paid in tangible legal tender and a separate float representative of an amount paid in virtual currency. The transaction information 124 may also comprise a float representative of a quantity of legal tender to be refunded by the merchant 104 to the member 102.

Those skilled in the art will recognize that tangible legal tender is a special kind of personal property, constituting government authorized coins, currencies and bank notes legally approved to serve as a medium of exchange and for payment of public and private obligations.

The legal tender may includes the Quintric™ monetary system, combining the legitimacy, accountability and security of gold and silver (“specie”) legal tender with the transparency, flexibility and convenience of distributed, blockchain technology to create the world's first authentic, interoperable family of specie legal tender cryptocurrencies. The Quintric system consists of five distinct, inter-dependent, specie-based tokens: Quint™; QuintS™; iQuint™; iQuintS™; and QuintX™.

In one embodiment, the financial event 118 may represent a purchase, sale, reinvestment, redemption, payment of a dividend, and so forth. In a further embodiment, at least some of the accounting information may be maintained in the global distributed ledger, such as a blockchain or the like.

In another embodiment, an apparatus may process and account for the steps of the method 500 or systems taught herein, facilitating creation of a financial event 118 between a merchant 104 and member 102 and/or another party who may or may not be an account holder within the system or with the technology provider, the apparatus being comprised of one or more digital processors configured to implement operations by means of the system 300 modules.

The DPD may be of any form factor or type, including an embedded system, a handheld, a notebook, a personal computer, a minicomputer, a server, a mainframe, a supercomputer, and the like.

The processor(s) 302 may be present in any quantity, including a uniprocessor, and may have any instruction set architecture. In an embodiment, the processor(s) may have one or more levels of dedicated or shared caches. Possible physical implementations may include multi-chip, single chip, multi-core, hyperthreaded processors, and the like.

The memory 116 may be of any size or organization and may include both read/write and read-only sections. It may also include both global and local sections, and may support both uniform and non-uniform access. It may incorporate memory-mapped I/O and direct memory access. It may support cache coherency, including directory-based and snoop-based protocols.

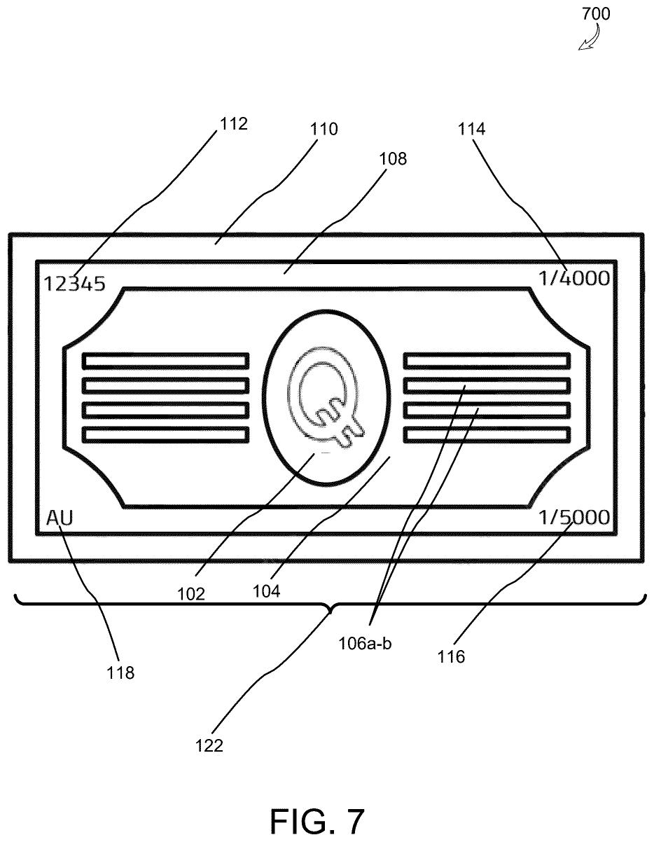

FIG. 7 is a forward perspective view illustrating one embodiment of a physical negotiable instrument 700 in accordance with the present invention.

The physical negotiable instrument 100 may comprise a cut flexible backing material 122 made of polymeric materials and/or paper, linen, or organic materials, shaped to standard geometries such as rectangle, square, ovoid and the like. The backing material 122 may comprise a flexible substrate.

In various embodiments, various markings are printed or inlaid on an obverse or reverse surface of the negotiable instrument 100. By way of example, in various embodiments, these markings including a seal 102, a serial number 112, a first denomination indicator of precious metal quantity 114, a second denomination indicator of precious metal quantity 116, a seal background 104, an inner border 108, an outer border 110, a precious metal identifier 118, and various other markings 106a-b.

The negotiable instrument 100 may be exchanged for U.S. legal tender, such as dollars, but the negotiable instrument 100 has inherent value because it incorporates one or more precious metals.

In various embodiments, the negotiable instrument 100 incorporates gold, silver, platinum, palladium, and the like (“precious metals”). The negotiable instrument 100 may be termed a “goldback” or a “silverback”.

The precious metals may be fused, adhered, plated, laminated or bonded to the backing material 122 using various technologies known to those of skill in the art, including WVPAB (water vapor assisted bonding) or use of amino- and mercaptosilanes to increase adhesion. Methods known in the art may produce layers of precious metal(s) within, or upon, the negotiable instrument 100 having low permeation rates from oxygen and moisture, a smooth uniform surface morphology, and resistance to temperature and chemical reactions. The is particularly important with some precious metals such as silver which are known to oxidize.

The thickness of the layer of precious metals may be between 10 nm and 1 mm. These precious metal layers also improve the optical and aesthetic characteristics of the negotiable instrument 100. The layers of precious metals may comprise foil of precious metal adhered to the backing material 122. In alternative embodiments, the back material 122 is a foil comprising a precious metal and one or more other substances or alloys operable to impart flexibility to the foil as known to those of skill in the art. The backing material 122 may comprise steel, aluminum, titanium, molybdenum and/or copper.

In various embodiments, the layers of precious metals are shaped to produce the markings indicated in FIG. 1. For instance, gold may be layered around the outside perimeter of the negotiable instrument 100 to create the outer border marking 110, or the seal 102 may comprise a precious metal layered upon a preexisting marking such as the seal backing 104.

The layers of precious metals, and the backing material, may be formed from cross-laid, interwoven, or non-woven fibers of precious metals. In various embodiments, the fibers used to create a layer alternate between a fiber made of a precious metal and a polymeric fiber, such as Kevlar, to impart flexibility and strength to the negotiable instrument 100.

The precious metal marking 118 indicates the predominate precious metal within the negotiable instrument 100.

In various embodiments, the layers of precious metals fused to the backing material 122 may be engraved and the marking created through engravature of one or more layers of precious metals.

The first denominated value indicated the quantity of a precious metal incorporated into the negotiable instrument 100. For instance, as shown, the negotiable instrument 100 may incorporate 1/4,000 of an ounce of gold. In other embodiments, negotiable instrument 100 incorporates 1/5,000 of an ounce of a precious metal. In still further embodiments, the negotiable instrument 100 incorporates 1/200, 1/20, 1/40, or 1/100 of an ounce, pound, gram, grain or kilogram.

The negotiable instrument 100 may be serialized using serial numbers 112.

Both a reverse surface and an obverse surface of the physical negotiable instrument 100 may be sealed or clear-coated with one of a flexible polymeric, silicone or urethane layer, enveloping the markings between clear-coated surfaces.

The negotiable instrument 100 might be produced for recognition by a state as legal tender, for instance pursuant to Article 1, Section 10 of the U.S. Constitution. Various states, such as Utah, also have a species legal tender acts, including 31 Utah C. Ann. § 5103, which provides that U.S. coins and currency (including federal reserve notes and circulating notes of federal reserve banks and national banks), are legally authorized. Thus, the negotiable instrument 100 may include the circulating notes of federal reserve banks and national banks.

These features and advantages of the present invention will become more fully apparent from the following description and appended claims, or may be learned by the practice of the invention as set forth hereinafter.

In order that the advantages of the invention will be readily understood, a description of the invention will be rendered by reference to specific embodiments that are illustrated in the appended drawings. These drawings depict only typical embodiments of the invention and are not therefore to be considered to be limiting of its scope.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Many of the functional units described in this specification have been labeled as modules, in order to more particularly emphasize their implementation independence. A module may comprise utilitarian objects of any kind, including mechanical structures or devices, electrical devices, electromechanical devices, optical devices, analog electronics, digital electronics, and so forth. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer-implemented method for creating a financial event file in computer-readable memory and facilitating a bi-directional financial transaction, the steps of the method comprising:
incorporating a merchant into a member network under the control of a technology provider by creating an encrypted virtual merchant account for the merchant in computer-readable memory within an RDBMS, the virtual merchant account comprising one or more of a name, mobile phone number, email, a unique numeric identifier exclusively associated with the merchant, and an account balance;
incorporating a member into a member network under the control of the technology provider by creating an encrypted virtual member account for the member in computer-readable memory within an RDBMS, the virtual member account comprising one or more of a name, mobile phone number, email, a unique numeric identifier exclusively associated with the merchant, and an account balance;
maintaining an encrypted global ledger of all transfers and balance changes occurring in a plurality of virtual member accounts and a plurality of virtual merchant accounts;
accepting into computer-readable memory from a merchant a financial event file originating with said merchant, created on a user interface displayed on a DPD, said DPD in logical communication with the technology provider via a WAN, the financial event file comprising:
the unique numeric identifier exclusively-associated with the merchant;
the unique numeric identifier exclusively-associated with the merchant;
a description of one of a good and service being purchased;
one of an email and a mobile phone number of the member;
a purchase price expressed as a float;
a first payment amount expressed as a float;
a second payment amount expressed as a float;
a refund amount expressed as a float and indicative of an amount of tangible currency to be refunded to the member;
uploading the financial event file by the merchant to the technology provider via the WAN;
downloading the financial event file by the member from the technology provider via the WAN;
transmitting from the technology provider to the member a unique confirmation number to be given to the merchant manually by the member;
uploading the unique confirmation number by the merchant to the technology provider via the WAN;
allocating digital currency from the virtual member account to the virtual merchant account in response to receipt of the unique confirmation number and authentication of an accuracy of the confirmation number;
recording into computer-readable memory a provider response to the item request, the provider response comprising an integer indicative of a price of the consumer good; and
recording into computer-readable memory a consumer acceptance of the provider response.

2. The method of claim 1, wherein the account balance indicates a quantity of digital currency escrowed in trust with the technology provider.

3. The method of claim 1, further comprising recording into computer-readable memory on a signal bearing medium geolocation information from a merchant and a member.

4. The method of claim 1, further comprising relaying to the member by the technology provider with real-time textual communication an SMS comprising the unique confirmation identifier.

5. The method of claim 1, further comprising relaying to the merchant a Boolean value evaluating as true in response to authentication of the unique confirmation.
